(19) United States
(12) Patent Application Publication
(10) Pub. No.: US 2009/0204662 A1
(43) Pub. Date: Aug. 13, 2009

(54) Method and system for providing reconciliation of semantic differences amongst multiple message service providers

(76) Inventor: Sam J. Meo, Holmes, NY (US)

Correspondence Address: Neville Law Group;Attn: Deborah Neville, PO Box 61063, Palo Alto, CA, 94306, US

(21) Appl. No.: 11/665,061

(22) PCT Filed: Oct. 18, 2005
(86) PCT No.: PCT/US05/37455

§ 371 Date: Apr. 10, 2007

Related U.S. Application Data
(60) Provisional application No. 60/620,434, filed on Oct. 20, 2004.

(51) Int. Cl. G06F 15/16

(52) U.S. Cl. 709/203; 709/246

(57) ABSTRACT

The invention provides a method and system to manage and resolve “impedance mismatches” between and among standards and among each standard's attending messaging protocols. The invention provides a messaging service manager whose implementation accommodates the occurrence of “translations” between and among various messaging service providers. ServiceManager™, a software-based messaging services manager, provides for integration of various heterogeneous web services in a single environment both at the level of explicit conversational differences and implicit special case semantics. The invention provides places in its implementation for such “translations” to occur between and among various messaging service providers. ServiceManager™ addresses the need for a solution to the unexpected alteration to a request/response set providing places in its implementation for such “special case” situations to be defined and handled. The invention provides a messaging service manager whose implementation accommodates the definition and handling of such “special case” situations.

### RELATED APPLICATIONS

This application is related to U.S. Provisional Application 60/620,434, filed Oct. 20, 2004, the entirety of which is incorporated by reference as if fully set forth herein, and priority is claimed from Oct. 20, 2004.

### GOVERNMENT FUNDING

Not Applicable.

### BACKGROUND

When telecommunications technology and computers were first brought together, the typical network topology showed a central site mainframe connected by telephone lines to many satellite dumb terminals. Over time, this “star” topology changed as both the number of mainframes at a central site increased and the number of dumb terminals increased. Over time, many different topologies were developed to address different kinds of network problems, mainly performance, availability and security.

With the arrival of personal computers, dumb terminals were replaced by machines with local processing capacity. This change in the location of processing power gave rise to various distributed network topologies, both at the hardware level and at the software architecture, design and implementation level.

For many years, mainframes remained at the center of a distributed network, but as software design became more sophisticated, more and more application functionality was placed in the end user's machine. This client/server model lasted for many years and provided computer science the time to understand all the issues of distributed function placement across a complex network.

With the advent of the internet and the world wide web, the client/server model was adopted and adapted, giving rise to the ubiquitous web server/client browser model. Again, with these systems, central control of function and data remained with the server; the client simply made requests for information. As software engineering and machine capability grew, client requests for information began to include requests for local task oriented functionality.

The last five years have seen the emergence of ‘web services’, also called ‘service oriented architectures’. Unlike the world wide web (also referred to herein as “the web”), which is concerned primarily with presentation and interaction with users, web services are generalized methods for exchanging data and functional services between and among machines. Along with broadband, web services technologies now enable the design of large distributed networked systems, including peer-to-peer systems, in which function placement (i.e., in which node in a network does a particular process occur) is no longer simply based on the size or location of a processing node, but rather the nature of the work.

Web services are defined as a set of structured request/response messages that expose a particular processing node's set of functionality made available for public use by other processing nodes. A collection of such request/response message enables a “conversation” to occur between two or more processing nodes that manages information distribution and distributed function placement.

In order for such a “conversation” to occur, each side of the conversation must agree beforehand as to the semantics of the messaging content and sequence of content within the conversation. Each conversation then, is like a mini-language with its own grammar, its own explicit vocabulary and very often, an unspoken implicit set of connotative meanings. However, this web services approach, while enabling request/response conversations, by its very nature creates problems for which solutions are needed.

One significant problem is how to reconcile the semantic differences between two or more sets of conversation grammars and vocabularies. Currently, there are many industry vertical standards bodies working hard to solve part of this problem by developing consistent and coherent grammars and vocabularies for a given industry vertical. However, solution of this problem by the vertical standards bodies necessarily creates a second level problem referred to as “impedance mismatching.”

Adoption of grammar and vocabulary standards within industry verticals exacerbates the need for horizontal integration across verticals. Horizontal integration requires a solution for “impedance mismatch” between and among various vertical standards and their attending messaging protocols. Impedance mismatch may be likened to the problem of translating a spoken conversation in which each side of the conversation is speaking a different language. Provided a degree of shared understanding of intent can be achieved, to just that degree can the conversation be considered to have real communicative value.

Shared understanding is not so easy to achieve. The construction of a so-called “semantic web” (as described by visionary Tim Berners-Lee) requires mechanisms be designed and built capable of managing and resolving “impedance mismatches” between and among various standards and their attending messaging protocols. No such mechanisms are currently commercially available. What is needed is a mechanism to manage and resolve impedance mismatches between and among standards and their attending messaging protocols.

Another significant problem concerns the often unspoken and implicit set of connotative meanings that color every conversation. In human conversation, we see this when two sides of a conversation seem to reach a clear and unambiguous agreement, for example, for each to take certain actions By way of example, two, in the example in which the agreement of the two sided conversation is “We'll meet at the corner of Fourth and Main at 4 o'clock,” it can seem to be understood as to specifying a specific time and place, unambiguously and clearly. However, when it comes time to perform the actions set forth in the agreement, observe that one side is on the Northeast corner at 4 o'clock EST, another on the southwest corner at 4 o'clock PST. Thus, after the apparent fact of a mutual agreement, it becomes clear through observing one or the other side's unexpected actions or non-performance that the agreement was not understood in the same way by each side, and, therefore, a flawed agreement.

In the world of standards and web services this problem appears as the problem of unspoken business rules that may unexpectedly alter the expected result of a request/response set. This problem is most acute within the content of large and well established legacy systems whose beginnings are often found in the early days of commercial computer systems implementation.

Because these hidden business rules are often not documented, the rules may be considered “special cases,” discovered as they make themselves known during web services operation. Commercial users cannot be expected to accept that failure of the system will be the first indication that a special case has been encountered. What is needed is a solution to the occurrence of unexpected alteration to a request/response set.

### BRIEF DESCRIPTION OF THE INVENTION

The invention (also referred to herein as “ServiceManager™) provides a mechanism to manage and resolve “impedance mismatches” between and among standards and among each standard's attending messaging protocols.

The invention provides a messaging service manager whose implementation accommodates the occurrence of “translations” between and among various messaging service providers.

The invention provides a software-based messaging services manager which addresses these problems by providing mechanisms to integrate various heterogeneous web services in a single environment both at the level of explicit conversational differences and implicit special case semantics. The inventive messaging service manager provides places in its implementation for such “translations” to occur between and among various messaging service providers.

ServiceManager™ addresses the need for a solution to the unexpected alteration to a request/response set providing places in its implementation for such “special case” situations to be defined and handled. The invention provides a messaging service manager whose implementation accommodates the definition and handling of such “special case” situations.

The current preferred embodiment is oriented toward internet travel-related services, however, the invention can be used in many other industry applications including but not limited to the legal, financial and medical industries.

### BRIEF DESCRIPTION OF THE DRAWINGS

FIG. 1 depicts a high level system use case diagram of the inventive system.

FIG. 2, A through C inclusive, depicts ServiceManager™ structure in a current embodiment.

FIG. 3 depicts pseudo-code for a simple transaction according to the invention.

FIG. 4 depicts pseudo-code for a complex transaction according to the invention.

### DETAILED DESCRIPTION OF THE PREFERRED EMBODIMENT

The invention, also referred to herein as ServiceManager™, provides a mechanism to manage and resolve impedance mismatches between and among standards and among each standard's attending messaging protocols.

ServiceManager™, a software-based messaging services manager, provides mechanisms to integrate various heterogeneous web services in a single environment both at the level of explicit conversational differences and implicit special case semantics.

ServiceManager™ provides places in its implementation for such “translations” to occur between and among various messaging service providers.

Moreover, ServiceManager™ addresses unexpected alterations to a request/response set and provides places in its implementation for “special case” situations to be defined and handled.

ServiceManager™ Architecture. As used herein, a namespace is defined as a collection of words and rules defining valid combinations of those words. Each namespace has a unique identifier. Each word in a namespace is prefixed with its namespace identifier to distinguished it from the same word occurring in a different namespace and perhaps having a different sense altogether.

ServiceManager™ reconciles differences between the messaging vocabulary and intent of messaging documents in the client namespace with those of the provider such that the client communicates with all providers using messaging documents in a single client namespace. It does this by using two techniques: 1) automated transformations from one namespace to another, and 2) transform extensions inserted into the transform process as needed for special handling.

The preferred implementation of the invention, ServiceManager™, uses several “Extended Markup” technologies:

1) Extended Markup (XML) in order to provide common encoding rules for all messages documents;

2) Xml Schema's (XSD) in order to provide validation rules for each message document;

3) XPath in order to provide search capabilities within XML documents;

4) Extensible style sheets (XSL) in order to provide transform rules between message documents;

5) Extension namespaces in order to provide mechanisms to implement special handling transforms.

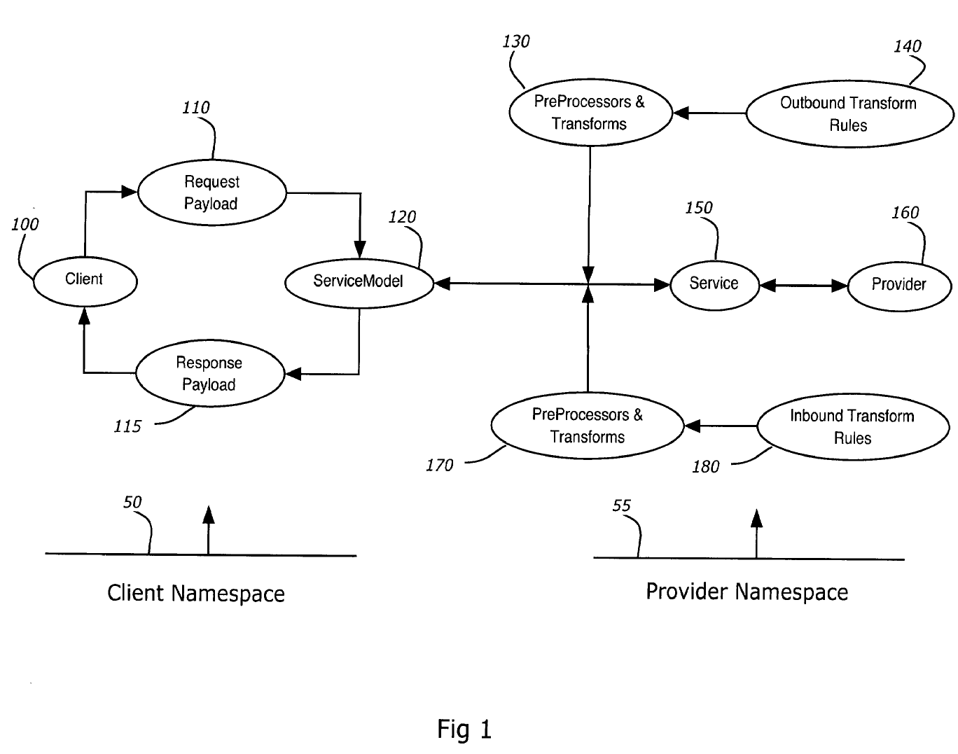

Referring to FIG. 1, the Client 100 component can be any arbitrary component, typically a UI (user interface) component or some middleware component. The Client 100 component submits a request message document, or Request Payload 110, to that Request's associated ServiceManager ServiceModel 120 component. Using the Preprocessors & Transforms 130 component, the ServiceModel 120 component determines whether the Request Payload 110 needs transformation from the Client Namespace 50 into the Provider (or Target) Namespace 55 of the intended response message document, or Response Payload 115, Provider 160. The Preprocessors & Transforms 130 component uses the Outbound Transform Rules 140 component to supply transform rules for that particular ServiceModel 120 document which it then applies to the Request Payload 110 message document. The Outbound Transform Rules 140 component is configured by a separate set of ServiceManager service configuration components (not shown).

Continuing on, the ServiceModel 120 then passes the now transformed Request Payload 110 to the Service 150 component. The Service 150 component houses all the transport processing rules needed to communicate with a particular Provider 160 or target, local or remote. The Service 150 component sends the Request Payload 110 to the Provider 160 and awaits a Response 115.

The Provider generated Response Payload 115 is then presented by the receiving received by the Service 150 component which the presents the Response Payload 115 to the originating ServiceModel 120 component. The ServiceModel 120 component then uses the PostProcessors & Transforms 170 component to determine whether the Response Payload 115 needs transformation from the Provider namespace 55 to the Client namespace 50. The PostProcessors & Transforms 170 component uses the Inbound Transform Rules 180 component to supply transform rules for that particular ServiceModel 120 document which it then applies to the Response Payload 115. The Inbound Transform Rules 180 component is configured by a separate set of ServiceManager™ service configuration components (not shown). The ServiceModel 120 then makes the Response Payload 115 available to the originating Client 100 component

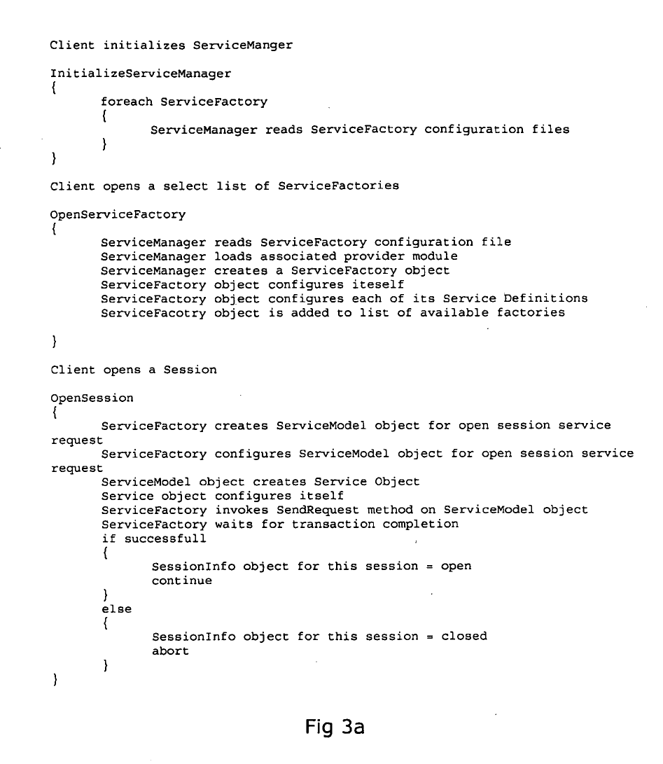

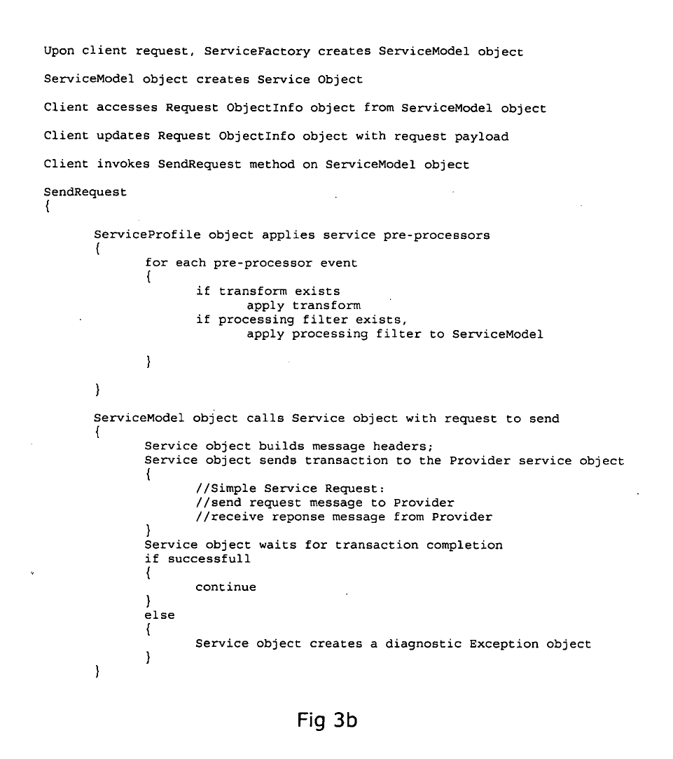

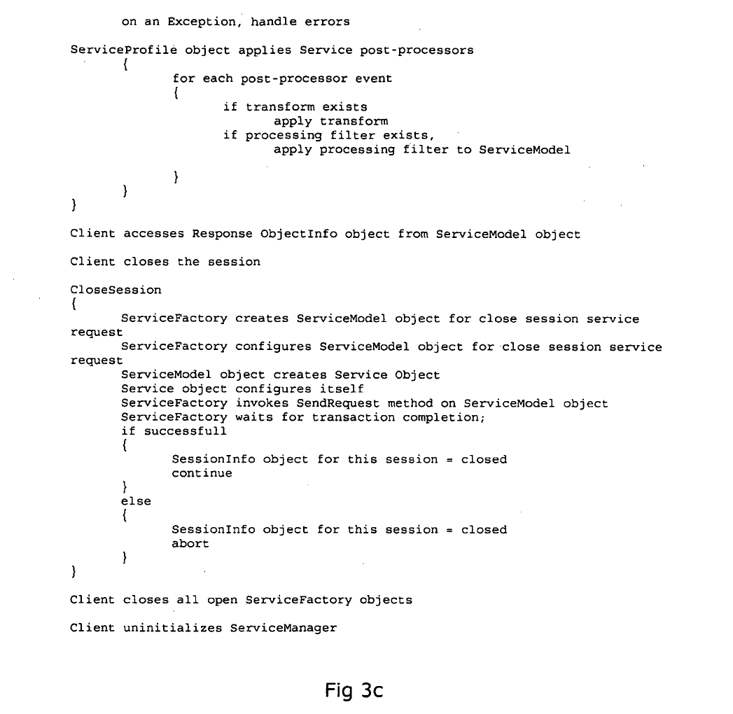

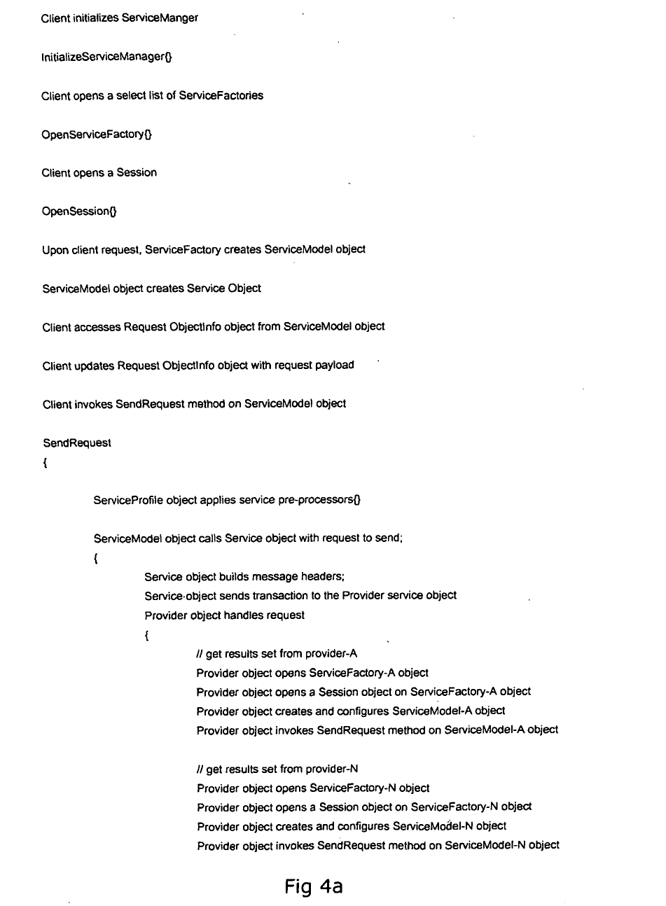

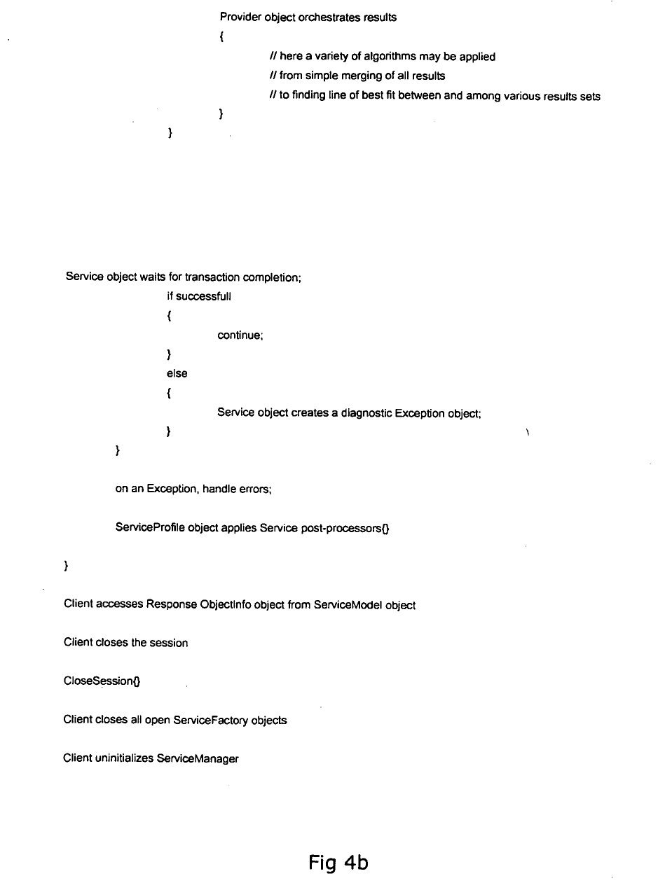

What follows is a description of a current codification of the inventive method and system. The recitation of this instantiation is not intended to limit the invention. Further, two examples follow derived from a travel reservation based application as currently embodying the inventive method and system. FIGS. 3 and 4 represent the pseudo-code derived from the client requests according to the present invention in a simple (FIG. 3) and a composite (FIG. 4) type transaction. Such description and examples are for the purposes of illustration and explanation and are not intended to limit the invention.

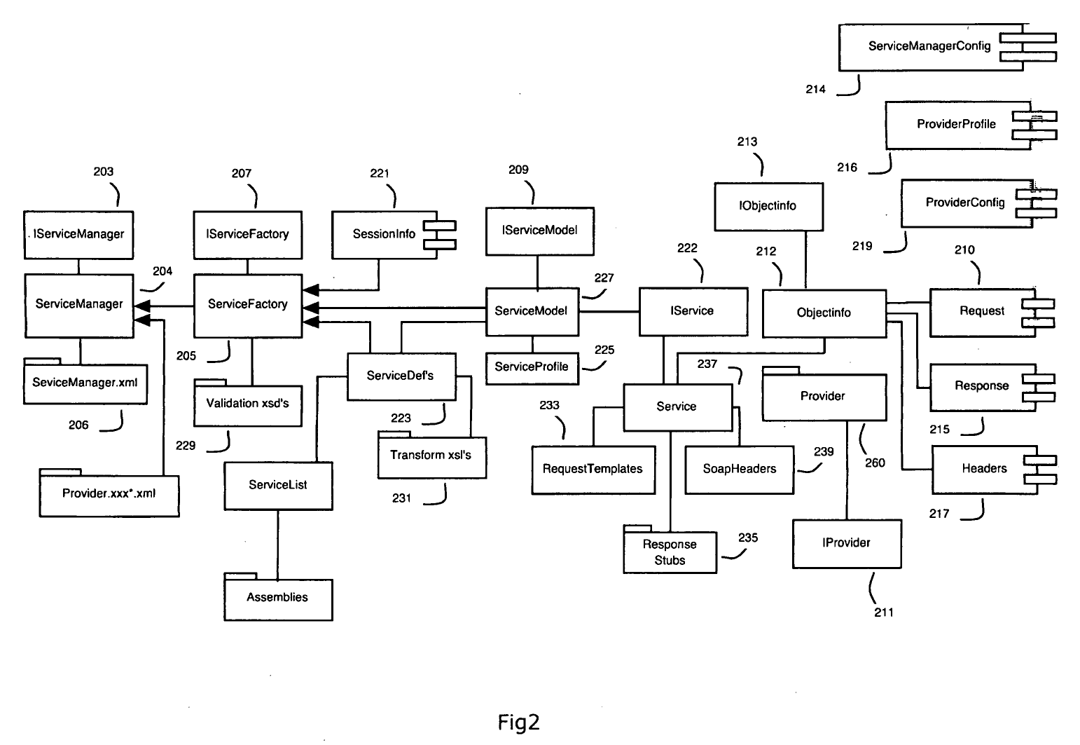

ServiceManager™ public interface. Referring to FIG. 2, all public access to ServiceManager™ is through a set of interfaces. Such a set of interfaces provides a clean separation between client and implementation. The underlying implementations are free to change so long as the semantics of the interface definitions are not changed.

IServiceManager interface. The IServiceManager 203 interface provides methods, properties and event notification triggers to manage a collection of ServiceFactory 205 objects. IServiceManager 203 identifies each available ServiceFactory 205 and enables the user to manage the state of each factory. For the purposes of this invention, a “factory” may be understood to be that which produces other objects upon request. Service Factory, upon request, produces ServiceModel and SessionInfo objects. Moreover, a factory is also a construct that manages various feature functions common to the set of ServiceModels that it as a factory knows how to create (e.g. session management and payload validation). Managing the state of the factory (for example, the factory may be in the state “available but closed”, or, alternatively “installed and open”), IServiceManager 203 also provides notification to the client if a network connection is lost.

IServiceFactory interface. The IServiceFactory 207 interface provides methods, properties and event notification triggers to manage a specific ServiceFactory 205. It identifies the client namespace in which all requests and responses are to be delivered to the client. It identifies Provider 260 access credentials and other configuration information to gain access to the list of services made available to the Client 100 by the Provider 260. It manages factory-wide parameters (e.g. timeouts), and supports logical session creation for Providers that require such. It also provides notification to the Client if a logical session is lost. It also provides support for request/response validation against service specific schema's. It supports multiple logical sessions per Provider.

IServiceModel interface. The IServiceModel 209 interface provides methods, properties and event notification triggers to manage transactional support for individual Provider services. It manages the state of requests and responses, as well as the construction of appropriate message headers. It binds a specific transaction to a specific session. It provides transaction completion status containing diagnostic information in the event of an error. This single interface is common for all service Providers. This interface provides an abstraction across all Providers.

IService interface. The IService 222 interface provides methods and properties to communicate with specific Providers. It provides for the construction of Request 210/Response 215/Headers 217 and the scheduling and execution of service transactions.

IProvider interface. The IProvider 211 interface provides methods and properties to support services made available through local (to the Client) providers, including Composite Providers.

IObjectInfo interface. The IObjectInfo 213 interface provides methods, properties and events to manage all key data objects, including any Request 210, Response 215, and various configuration property objects. It provides transform properties to convert native object instances into either DOM's or XML documents. These transforms are transitive, or reversible operations.

ServiceManager™ public components comprise: the IServiceManager 203 interface, the IServiceFactory 207 interface, the IServiceModel 209 interface, the IService 222 interface, and the IObjectInfo 213 interface.

IServiceManager. Communication between client and the ServicesFactories 204 object is through the IServiceManager 203 interface. The ServiceManager 204 object is a singleton object. It uses a set of configurations files to build a list of potential Providers, Provider access credentials, Provider session requirements, and it verifies the existence of the pluggable component for each Provider. When the client requests to open a ServiceFactory 205, the ServiceManager 204 object will locate the ServiceFactory module, load the module and call that module's constructor. In certain cases, additional methods ServiceFactory 205 methods will be invoked to complete the configuration of the ServiceFactory 205 before it is made available for use by the client.

ServiceManager.xml 206 is the root configuration file. It enumerates all available provider details, containing references to provider specific configuration files. In the current implementation, such information is contained in the ServiceManagerConfig 214, ProviderProfile 216, and ProviderConfig 219 objects.

The IServiceFactory 207 interface enables communication between client and the ServiceFactory 205 object. The ServiceFactory 205 object is dynamically loaded by the ServiceManager 204 object upon client request. The ServiceFactory 205 manages all session related processing for its associated Provider, allowing null session support if none is needed, and allowing for multiple concurrent session support when allowed by the Provider. It can log all transactions for later audit and review, and supports replay of such transactions for off-line diagnostic testing. It maintains all session information for each Provider in the SessionInfo 221 object. And finally, it uses the ServiceDef 223 object to dynamically configure each service supported by the associated Provider.

The SessionInfo 221 object contains dynamic data for each active session, as well as timeout and keep-alive mechanisms for each active session. The number of sessions is configurable at run-time. Again, null sessions are supported for those providers that do not require session management. In these cases, all open or close session requests made upon a provider not requiring session management are effectively empty functions (i.e. they perform no operation). This allows client code to treat all providers as requiring session management, even though, in fact, not all do so.

The ServiceDef 223 object uses a dynamically generated configuration file, resulting from a prior analysis of service definition files (e.g. wsdl's), optimized to allow rapid instantiation of specific versions of specific service data types. Typically these datatypes include those for proxy requests and responses, message headers, and service object. For each service, the SerfiveDef object also contains ServiceProfile 225 information, used by the ServiceModel 227, to transform client-side requests into Provider specific request formats and Provider specific response formats into client-side responses.

The ServiceConfigurator (not depicted) is a separate off-line component that accepts a list of service definitions (wsdl's). An analysis of the wsdl content produces a set of configuration files that are used on-line the ServiceManager itself to configure the various aspects of each web service. Each Provider has its own set of service definitions. For each set of service configurations, there must be an associated executable module (e.g., a dotNet Assembly packaged as a dynamic link library) containing Provider specific client-side web service methods (e.g. proxy classes and associated service class).

Optional XML Schema Definitions files (Validation xsd's 229) for each service request and response are included in the ServiceDef component. The client may request a ServiceFactory 205 to validate the form of a specific request or response and report back a list of diagnostic messages in the case of errors.

XML StyleSheets (Ttransform xsl's 231) may be included to govern the automated transformation of an xml document from one namespace to another (e.g. from client-side request namespace to provider-side request namespace and back).

Optional XML documents for service Request Templates 233 and Response Stubs 235 are included in the ServiceDef 223 component. It is possible to instruct ServiceManager™ to use these cached documents in lieu of client-provided request and responses in service of testing or transaction replay.

Communication between client and the ServiceModel 227 object is through the IServiceModel 209 interface. The ServiceModel 227 object manages the lifecycle of a service transaction using the same set of semantics for all transactions. (The Service 237 object manages semantic differences between and among Providers). An instantiated ServiceModel 227 calls upon the Service 237 object to create ObjectInfo 212 objects for its Request 210 and its Response, 215 and all associated Headers 217 that may be involved. The Response object is not valid until the SendRequest method is made on the ServiceModel 227. The client prepares the Request object through the IServiceModel interface with a specific service request payload and then calls the SendRequest method, again through the IServiceModel interface, to execute the service transaction. The transaction is executed within the context of a specific assigned open session through the associated Service 237 object using the IService 222 interface. Upon completion of the service request, either the Response object becomes valid or a diagnostic exception is provided. Both Request 210 and Response 215 objects remain alive until the ServiceModel 227 is destroyed. The ServiceModel 227 is a serially reusable resource.

A ServiceProfile 225 is a collection of methods identified by trigger event for that service. During the lifetime of a service transaction, as it passes through various finite states, some of those states have triggered events associated with them and are fired at that time. Basic examples include pre-send filters, post-receive filters, and filters determining session state requirements for a particular service.

Communication between client and the Service 237 object is through the IService 222 interface. The Service 237 object does the actual communication with the Provider 260. It generates appropriate message headers and executes the network transaction. It may provide request templates to be completed by the client before sending, or it may provide replay of previous transactions. This Service 237 object is the only object in the system that has semantic knowledge of the Provider 260.

The Request 210 object may be pre-populated with a Request Template 233. Each Provider may specify specific formats for its request and response headers. The SoapHeader 239 object knows how to build Provider specific message headers.

The Provider 260 is a network resource with a defined URL endpoint that receives (web) service requests and returns associated responses within its own semantics.

Communication between client and the ObjectInfo 212 object is through the IObjectInfo 213 interface. The ObjectInfo 212 object manages key data objects, including Request 210, Response 215, Header 217 and various configuration objects; and provides a single set of access semantics over these objects.

The types of service may be Simple or Composite. A Simple service is defined as a transaction with a single request out and a single response back. A Composite service is defined as a single request whose execution includes a coordinated set of more than one Simple service transactions whose responses are integrated into a single Composite response.

A Composite service may be goal oriented. The original request contains a set of parametric constraints in search of an optimum best fit solution and the Composite service develops a orchestrated plan for arrive at such, perhaps using advanced techniques such as combinatorics. In this manner, web services can be orchestrated to perform a higher level task by means of constraining performance of sub-tasks, and thus provide the user may get “best fit” results. For example, a user can choose preferences of price as of higher priority than schedule/time considerations. Consequently, the building of an itinerary accommodating user prioritized preferences can approximate a “best fit” construction. The concept of optimized or optimization itinerary planning, wherein User preferences are accommodated by means of “best fit” or goal based bookings” can be satisfied by the invention as taught herein.

FIG. 3 provides an example of pseudo-code representative of a simple request (i.e. a request involving a single Provider). Briefly: the pseudocode recounts the following process elements:
Client: initializes ServiceManager
Client opens a ServiceFactory
Client opens a session
Client creates a ServiceModel
Client prepares a ServiceModel Request
Client invokes SendRequest method on ServiceModel
ServiceModel pre-processes the Request
ServiceModel invokes Simple Service Request on Provider
ServiceModel post-processes the Response
ServiceModel delivers the Response
Client closes the session
Client closes the ServiceFactory
Client un-initializes ServiceManager

And FIG. 4 provides an example of pseudo-code describing a composite transaction (i.e. a Request involving more then one Provider) as follows:
Client initializes ServiceManager
Client opens a ServiceFactory
Client opens a Session
Client creates a ServiceModel
Client prepares a ServiceModel Request
Client invokes a SendRequest method on ServiceModel
Composite Service Request: invoking an orchestration service
ServiceModel invokes Simple Service Request on Provider
ServiceModel delivers the Response
Client closes the Session
Client closes the ServiceFactory
Client un-initializes ServiceManager

It may be noted that the trend approaches departure of the client-server model and approaches peer to peer brokered web services, The orchestration of web services (dumb widgets) to perform tasks is migrating to appear more like a personalized—agent for any User such that tasks are accomplished in a coordinated manner

We claim:

1. A method for reconciling semantic differences between a requester and a responder message service providers, wherein said method comprising the steps of:
a) submission by a requester (Client) of a request message document to said request message's associated “ServiceModel” component;
b) determination by a ServiceModel component by means of application of a pre-configured “Preprocessors & transforms” component as to whether the request message document needs transformation from the Client namespace into the target namespace of the intended response message document provider (Provider);
c) applying Outbound Transform Rules by the Preprocessors & Transforms component to the request message document to create a transformed request message document;
d) passing the transformed message request document to a Service component, said Service component containing such transport processing rules as needed to communicate with Provider;
e) sending the transformed message request document by the Service component to the Provider;
f) generation by the Provider of a provider response to the transformed message;
g) receiving of said provider response by the Service component;
h) transmission of the provider response by the Service component to the ServiceModel component;
i) application by the ServiceModel component of “PostProcessors & Transforms” component, wherein said PostProcessors & transforms component is preconfigured with Inbound Transform Rules;
j) determination by the ServiceModel as to whether the provider response needs transformation from the Provider namespace to the Client namespace;
k) transformation of the provider response by the ServiceModel to create a transformed provider message;
l) transmission of the transformed provider message to the Client.

2. A system for managing and resolving mismatches between and among standards and among each standard's attending messaging protocols, said system comprising:
a) means for generating request from a requester in a first namespace;
b) means for translating request from a first namespace into a translated request compatible with a second namespace with a provider therein, such translated request sufficient for the responder to generate a response;
c) means for translating the response from the second namespace into a translated response compatible with the first namespace sufficient for the first namespace to acknowledge the translated response as a response to the request.

3. A method for integrating web services, said method comprising the steps of:
a) generating request from a requester in a first namespace;
b) translating request from a first namespace into a translated request compatible with a second namespace with a provider therein, such translated request sufficient for the responder to generate a response;
c) translating the response from the second namespace into a translated response compatible with the first namespace sufficient for the first namespace to acknowledge the translated response as a response to the request.

4. A medium for storing processor control instructions for a computer or the like, the medium including intercommunicable modules sufficient to resolve semantic differences between a request message and a response thereto, said modules comprising:
a ServiceModel associated with a request originator and operable to apply translation rules to both a request and a response where such request and response originate from more than one namespace, said ServiceModel intercommunicable with:
i) a preprocessor/transform module operable to communicate with a outbound transform rule module
ii) a postprocessor/transform module operable to communicate with an inbound rule module.

5. A system enabling translations to occur between and among various messaging service providers comprising:
a) a Client component, wherein said Client component submits a request message document to that message's associated ServiceModel component;
b) a ServiceModel component operable to use the Preprocessors & Transforms component so as to determine whether the request message document needs transformation from the client namespace into the target namespace of the intended response message document provider;
c) a Preprocessors & Transforms component, operable to use an Outbound Transform
Rules component configured by a set of ServiceManager service configuration components, to supply transform rules for that particular ServiceModel document and then applies to the request message document and passes the transformed request message document to a Service component;
d) a Service component, housing all the transport processing rules needed to communicate with a particular local or remote provider, and operable to send the transformed request message document to the provider and await a response message document;
e) a receiving Service component operable to send the response message document to the originating ServiceModel component, whereupon the ServiceModel component then uses the PostProcessors & Transforms component to determine whether the response message document needs transformation from the provider namespace to the client and, if so, duly translates the response message document before transmitting the response message document to the originating requester.

6. A method as in claim 3 where a single Provider responds to a request.

7. A method as in claim 3 where more than one Provider responds to a request.

8. A method as in claim 7 wherein a request further includes a set of parametric constraints such that the corresponding response is an optimization of search results.

9. A method as in claim 8 wherein the request involves more than one Provider.

10. The method as in claim 9 wherein a technique is used to determine an optimized response.

11. The method as in claim 10 where the technique is combinatorics.

12. The method as in claim 3 wherein user preferences or goals orchestrate requests and constrain Provider responses so as to determine optimization of responses.

13. The method as in claim 12 where the user seeks travel related reservations.
